(19) United States
(12) Patent Application Publication
(10) Pub. No.: US 2025/0147720 A1
(43) Pub. Date: May 8, 2025

(54) SYSTEM AND METHOD FOR GENERATING AUDIO DURING TRAVERSING OF A USER INTERFACE

(71) Applicant: SAMSUNG ELECTRONICS CO., LTD., Suwon-si (KR)

(72) Inventors: Sumit PANWAR, Noida (IN); Avinash SINGH, Noida (IN)

(73) Assignee: SAMSUNG ELECTRONICS CO., LTD., Suwon-si (KR)

(21) Appl. No.: 18/778,108

(22) Filed: Jul. 19, 2024

Related U.S. Application Data
(63) Continuation of application No. PCT/KR2024/008006, filed on Jun. 11, 2024.

(30) Foreign Application Priority Data
Nov. 3, 2023 (IN) 202311075301

(51) Int. Cl. G06F 3/16; G10L 15/16; G10L 15/18

(52) U.S. Cl. CPC G06F 3/167; G06F 3/165; G10L 15/16; G10L 15/1815

(57) ABSTRACT

A method for generating an audio signal includes capturing, during a traversal event, at least one audio stream associated with one or more of a content, an ambient audio stream, and at least one user interface (UI) frame; obtaining a set of audio features, and obtaining one or more of UI elements; determining an audio gain based on a prioritization and a weighted average of the extracted set of audio features; determining a UI context based on a UI contextual score of the extracted one or more UI elements; obtaining an audio map comprising at least one biased audio file and at least one unbiased audio file; and obtaining the audio signal based on a priority order assigned to the at least one biased audio file and the at least one unbiased audio file associated with the audio map.

### CROSS-REFERENCE TO RELATED APPLICATIONS

This application is a continuation of PCT International Application No. PCT/KR2024/008006, which was filed on Jun. 11, 2024, and claims priority to Indian Patent Application No. 202311075301, filed on Nov. 3, 2023, the disclosures of each of which are incorporated by reference herein their entirety.

### BACKGROUND

### 1. Field of Invention

The disclosure relates to a user interface of a device, and more particularly, to a method and a system for generating audio while navigating the user interface in a user device.

### 2. Description of Related Art

A user interface (UI) is pivotal in enabling users to interact and communicate with various user devices, thus enhancing the overall experience for users. A key aspect of such interaction is the audio component, which plays a crucial role in providing feedback and aiding navigation within the UI. However, related methods of implementing audio user interfaces have been limited by their reliance on pre-generated audio files, resulting in a fixed listening navigation experience for users.

In the current paradigm, the audio user interfaces may be tightly coupled with pre-generated audio files that play back upon the selection of a particular content or interaction, thereby rigidly restricting the Audio UI to the pre-existing set of audio files available within the system. Consequently, users are confined to a predefined set of audio cues and prompts, limiting the overall flexibility and personalization of the user experience.

Moreover, the pre-generated audio playbacks fail to establish a meaningful connection with UI elements or actions being performed by the user while navigating the UI. Thus, a lack of synchronization between the audio while navigating and traversing UI elements further hampers the user experience, rendering the interaction with the user device less intuitive and engaging.

The relating technologies lack an innovative approach to user interaction with the UI. The relating technologies fail to provide context-aware audio associations with UI elements thus diminishing the user experience. The related reliance on pre-generated audio files renders the UI interaction less intuitive, lacking dynamic, and personalized audio experience for the users.

### SUMMARY

According to an aspect of the disclosure, a method for obtaining an audio signal during a traversal event associated with a user interface (UI), may include capturing, during the traversal event indicative of performing navigation on the UI, at least one audio stream associated with content, an ambient audio stream, and at least one UI frame. According to an aspect of the disclosure, a method for obtaining an audio signal during a traversal event associated with a user interface (UI), may include obtaining a set of audio features based on the at least one audio stream and the ambient audio stream, and obtaining one or more UI elements from a set of images generated based on the at least one UI frame. According to an aspect of the disclosure, a method for obtaining an audio signal during a traversal event associated with a user interface (UI), may include determining an audio gain based on a prioritization and a weighted average of the set of audio features, wherein the audio gain indicates an intensity of the at least one audio associated with the UI. According to an aspect of the disclosure, a method for obtaining an audio signal during a traversal event associated with a user interface (UI), may include determining a UI context based on a UI contextual score of the one or more UI elements, wherein the UI context indicates context of activities during the traversal event in the UI. According to an aspect of the disclosure, a method for obtaining an audio signal during a traversal event associated with a user interface (UI), may include obtaining an audio map comprising at least one biased audio file and at least one unbiased audio file, wherein the at least one biased audio file is determined based on the set of audio features and the at least one unbiased audio file is determined based on the UI context. According to an aspect of the disclosure, a method for obtaining an audio signal during a traversal event associated with a user interface (UI), may include obtaining the audio signal based on a priority order assigned to the at least one biased audio file and the at least one unbiased audio file associated with the audio map, the set of audio features, and the audio gain, such that the generated audio signal is rendered during the traversal event on the UI.

According to an aspect of the disclosure, an electronic device for obtaining an audio signal during a traversal event associated with a user interface (UI) may include a memory storing one or more instructions. According to an aspect of the disclosure, an electronic device for obtaining an audio signal during a traversal event associated with a user interface (UI) may include one or more processors operatively coupled to the memory and configured to execute the one or more instructions, wherein of the one or more instructions, when executed by the one or more processors. According to an aspect of the disclosure, one or more processors may be configured to capture, during the traversal event, at least one audio stream associated with content, an ambient audio stream, and at least one UI frame, wherein the traversal event is indicative of performing navigation on the UI. According to an aspect of the disclosure, one or more processors may be configured to obtain a set of audio features based on the at least one audio stream and the ambient audio stream, and obtain one or more UI elements from a set of images generated based on the at least one UI frame. According to an aspect of the disclosure, one or more processors may be configured to determine an audio gain based on a prioritization and a weighted average of the set of audio features, wherein the audio gain indicates an intensity of the at least one audio associated with the UI. According to an aspect of the disclosure, one or more processors may be configured to determine a UI context based on a UI contextual score of the one or more UI elements, wherein the UI context indicates context of activities during the traversal event in the UI. According to an aspect of the disclosure, one or more processors may be configured to obtain an audio map comprising at least one biased audio file and at least one unbiased audio file, wherein the at least one biased audio file is determined based on the set of audio features and the at least one unbiased audio file is determined based on the UI context. According to an aspect of the disclosure, one or more processors may be configured to obtain the audio signal based on a priority order assigned to the at least one biased audio file and the at least one unbiased audio file associated with the audio map, the set of audio features, and the audio gain such that the audio signal is rendered during the traversal event on the UI.

One embodiment provides a machine readable medium containing instructions. The instructions, when executed by at least one processor, may cause the at least one processor to perform the method corresponding.

To further clarify the advantages and features of the present embodiments, a more particular description of the embodiments will be rendered by reference to specific embodiments thereof, which is illustrated in the appended drawing. It is appreciated that these drawings depict only example embodiments and are therefore not to be considered limiting its scope. The embodiments will be described and explained with additional specificity and detail with the accompanying drawings.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an environment for the implementation of a system for generating an audio signal during a traversal event associated with a User Interface (UI) corresponding to a user device, according to an embodiment;

FIG. 2 illustrates an exemplary general architecture of the system, according to an embodiment;

FIG. 3 illustrates a high-level architecture of modules and components of the system of FIG. 2, according to an embodiment;

FIG. 4 illustrates a block diagram associated with a capturing module of the system, according to an embodiment;

FIG. 5 illustrates a block diagram associated with a feature extraction module of the system, according to an embodiment;

FIG. 6 illustrates a block diagram associated with an audio formation module of the system, according to an embodiment;

FIG. 7 illustrates a process flow of determining an audio map with a UI audio determination sub-module associated with the audio formation module of the system, according to an embodiment;

FIG. 8 illustrates a block diagram associated with an audio generation module of the system, according to an embodiment;

FIG. 9 illustrates a block diagram associated with a rendering module of the system, according to an embodiment;

FIG. 10 illustrates a use-case of the system for generating the audio signal during the traversal event associated with the UI corresponding to the user device, according to an embodiment;

FIG. 11A illustrates another use-case of the system for generating the audio signal during the traversal event associated with the UI corresponding to the user device, according to an embodiment;

FIG. 11B illustrates another use-case of the system for generating the audio signal during the traversal event associated with the UI corresponding to the user device, according to an embodiment;

FIG. 12 illustrates yet another use-case of the system for generating the audio signal during the traversal event associated with the UI corresponding to the user device, according to an embodiment;

FIG. 13 illustrates yet another use-case of the system for generating the audio signal during the traversal event associated with the UI corresponding to the user device, according to an embodiment;

FIG. 14 illustrates another use-case of the system 200 for generating the audio signal during a physical event, while the user device 102 is operated, according to an embodiment;

FIG. 15 illustrates an exemplary process flow comprising a method for generating the audio signal during the traversal event associated with the UI corresponding to the user device, according to an embodiment.

### DETAILED DESCRIPTION

It should be understood at the outset that although illustrative implementations of the embodiments of the present disclosure are illustrated below, embodiments of the disclosure may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the present embodiments. Furthermore, in terms of the construction of the device, one or more components of the device may have been represented in the drawings by conventional symbols, and the drawings may show only those specific details that are pertinent to understanding the embodiments of the present embodiments so as not to obscure the drawings with details that will be readily apparent to those of ordinary skill in the art having the benefit of the description herein.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do NOT exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

Embodiments of the present disclosure will be described below in detail with reference to the accompanying drawings.

According to an embodiment, the present disclosure discloses a method and a system for generating an audio signal during a traversal event associated with a User Interface (UI). The present disclosure provides a technically advanced solution by creating contextualized audio during interactions of the user with the UI corresponding to a user device. The objective is to enhance and provide sophisticated UI navigation for the user device. Thus, the present disclosure provides a solution to generate and play audio content that is contextually relevant to the UI. The present disclosure discloses associating and producing audio that aligns with the context of UI interactions such that the user experience is elevated and enriched while using the user device.

The detailed methodology is explained, in accordance with non-limiting examples, in the following paragraphs.

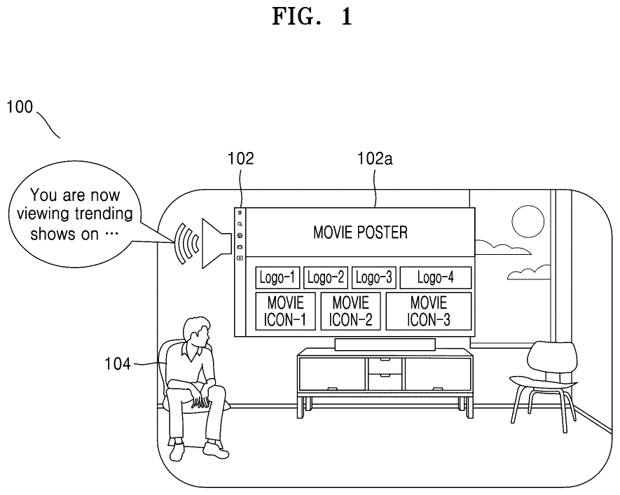

FIG. 1 illustrates an environment 100 for the implementation of a system for generating an audio signal during a traversal event associated with a user interface (UI) 102a corresponding to a user device 102, according to an embodiment.

According to an embodiment, a user 104 may be performing the traversal event while interacting with the user device (UD) 102. In an example, the UD 102 may be a laptop computer, a desktop computer, a personal computer (PC), a notebook, a smartphone, a tablet, a smartwatch, a smart television, a smart refrigerator or any device capable of displaying electronic media. In an example, the traversal event may be indicative of performing navigation on the UI 102a corresponding to the user device 102. Further, the user 104 interacting with the UD 102 may indicate the remote operating of the UD 102. In an example, the user 104 may be remotely operating the user device 102 to navigate the UI 102a associated with the user device 102 such as for fixing configuration settings of the UD 102, exploring features of the UD 102, and accessing an application installed in the user device 102. The traversal event may correspond to the user operating a remote device to move a cursor on a screen from one icon (e.g., “MOVIE ICON-1) to another icon (e.g., “MOVIE ICON-2). In an example, the application may indicate a content streaming application providing audio or video content. Thus, the user 104 may be performing the traversal event while interacting with the UI 102a which consequently leads to a generation of the audio signal. In an example, the audio signal may be indicative of a context-aware audio associated with the traversal event which is rendered by the UD 102 while the user 104 navigates the UI 102a. In an example, the audio signal may be effect sound associated with the traversal event. In an example, the audio signal may be message signal associated with the traversal event. In an example, the audio signal may be specific set signal associated with the traversal event. Thus, the audio signal represents audio content which is relevant and associated to the UI 102a. It may be apparent that the audio signal may be rendered on one or more UD 102, within the scope of the embodiments of the present disclosure.

A detailed methodology to generate and render the audio signal is explained in the following paragraphs of the disclosure.

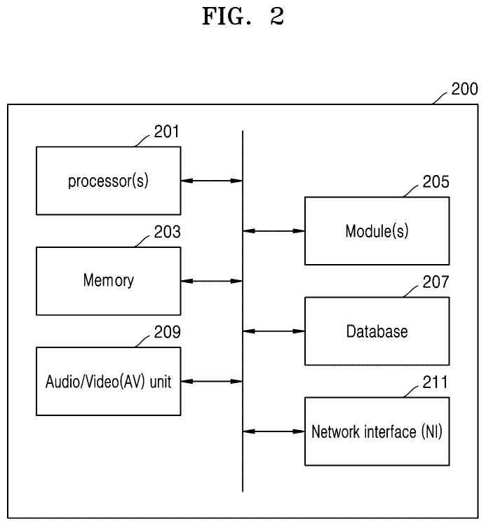

FIG. 2 illustrates an exemplary general architecture of the system 200 to implement a method for generating the audio signal during the traversal event associated with the UI 102a, according to an embodiment. The system 200 includes at least one processor 201, at least one memory 203, at least one module 205, a database 207, an Audio/Video (AV) unit 209, and a network interface (NI) 211 coupled with each other.

As an example, the system 200 may be implemented in the UD 102 shown in FIG. 1. In an example, the system 200 may be implemented in one or more UDs such as a laptop computer, a desktop computer, a personal computer (PC), a notebook, a smartphone, a tablet, a smartwatch, a smart television or any other machine capable of executing a set of instructions related to the implementation of the method for generating the audio signal. According to an embodiment, the system 200 may be implemented at a cloud server which is further connected with the PC, a desktop computer, or any other suitable electronic device known to one of ordinary skill in the art for implementing the method for generating the audio signal.

In an example, the at least one processor 201 may be a single processor or a plurality of processor, all of which could include multiple computing units. The processor 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201 is configured to fetch and execute computer-readable instructions and data stored in the memory 203.

The memory 203 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

As an example, the module(s) 205 may include a program, a subroutine, a portion of a program, a software component, or a hardware component capable of performing a stated task or function. As used herein, the module(s) 205 may be implemented on a hardware component such as a server independently of other modules, or a module can exist with other modules on the same server, or within the same program. The module(s) 205 may be implemented on a hardware component such as processor one or more microprocessors, microcomputers, microcontrollers, digital signal processors, central processing units, state machines, logic circuitries, and/or any devices that manipulate signals based on operational instructions. The module(s) 205 when executed by the processor(s) 201 may be configured to perform any of the described functionalities.

As an example, the database 207 may be implemented with integrated hardware and software. The hardware may include a hardware disk controller with programmable search capabilities or a software system running on general-purpose hardware. The examples of the database 207 are, but are not limited to, in-memory databases, cloud databases, distributed databases, embedded databases, and the like. The database 207, amongst other things, serves as a repository for storing data processed, received, and generated by one or more of the processors, and the modules/engines/units.

In an embodiment, the module(s) 205 may be implemented using one or more AI modules that may include a plurality of neural network layers. Examples of neural networks include but are not limited to, Convolutional Neural Network (CNN), Deep Neural Network (DNN), Recurrent Neural Network (RNN), and Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques include but are not limited to supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

As an example, the AV unit 209 receives audio data and video data from any third party. As a further example, the NI unit 111 establishes a network connection with a network like a home network, a public network, a private network, or any other suitable network known to one of ordinary skill in the art.

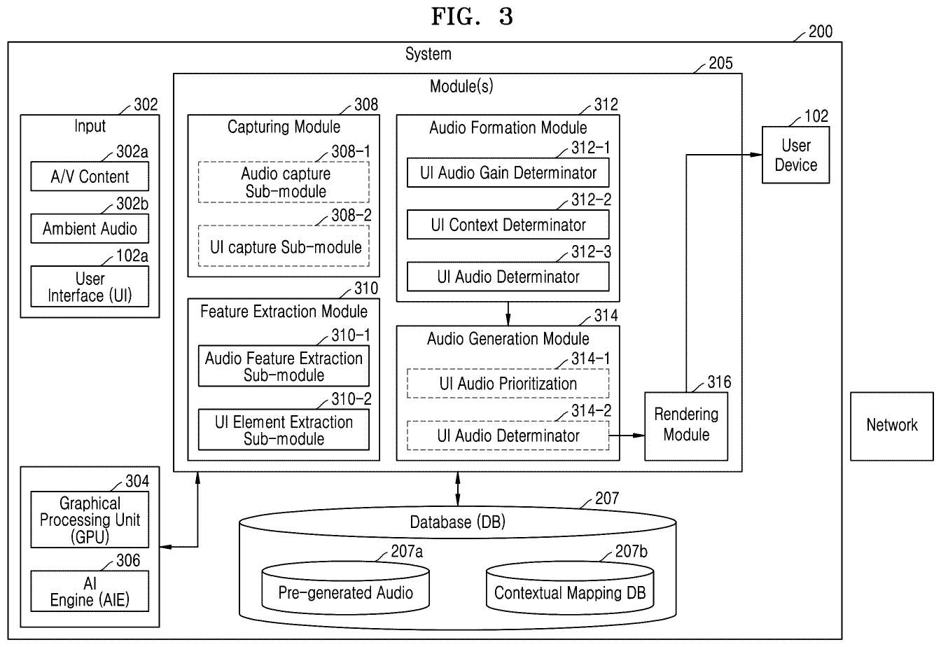

FIG. 3 illustrates a high-level architecture of modules and components of the system of FIG. 2, according to an embodiment of the present disclosure. In an embodiment, the module(s) 205 of the system 200 further include a capturing module 308, a feature extraction module 310, an audio formation module 312, an audio generation module 314 and a rendering module 316 coupled and collectively operating with each other. The aforementioned modules are further coupled with the graphical processing unit 304, an Artificial Intelligence (AI) engine 306, the database 207, and the UD 102 and collectively operate with each other.

In an embodiment, the module 205 may receive an input 302. The input 302 may include at least one of an audio/video content alternatively referred to as the content 302a within the scope of the embodiments of the present disclosure, an ambient audio 302b, and the user interface 102a. In an example, the input 302 may be resultant of the user 104 performing the traversal event associated with the UI 102a of the user device 102.

In an embodiment, the capturing module 308 may further include an audio capture sub-module 308-1 and a UI capture sub-module 308-2. Further, the feature extraction module 310 may include an audio feature extraction sub-module 310-1 and a UI element extraction sub-module 310-2. In an example, the audio formation module 312 may include a UI audio gain determinator sub-module 312-1, a UI context determinator sub-module 312-2, and a UI audio determinator sub-module 312-3. Further, the audio generation module 314 may include a UI audio prioritization sub-module 314-1 and a UI audio determinator sub-module 314-2. In an example, the database 207 of the system 200 may include a plurality of pre-generated audio files 207a, alternatively referred to as the pre-generated audio files 207a for brevity. In an example, the database 207 may include a contextual mapping 207b of the pre-generated audio files 207a with a corresponding application based on a context of the application. According to an embodiment, various functions of the module(s) 205 can be performed by the processor 201 of FIG. 2. However, for ease of understanding, an explanation is provided with respect to various module(s). In an embodiment, the module(s) may be a set of instructions that may be stored in the memory 203. The processor 201 may execute the set of instructions thereby performing an operation of these module(s) 205.

According to an embodiment, the UD 102 may include at least a display and the user interface UI 102a such as a graphical user interface. A detailed working and explanation of the various module(s) 205 of FIG. 3 will be explained in the forthcoming paragraphs. A detailed working of the system 200 will be explained through various components of FIG. 2 in the forthcoming paragraphs through FIGS. 1 to 15.

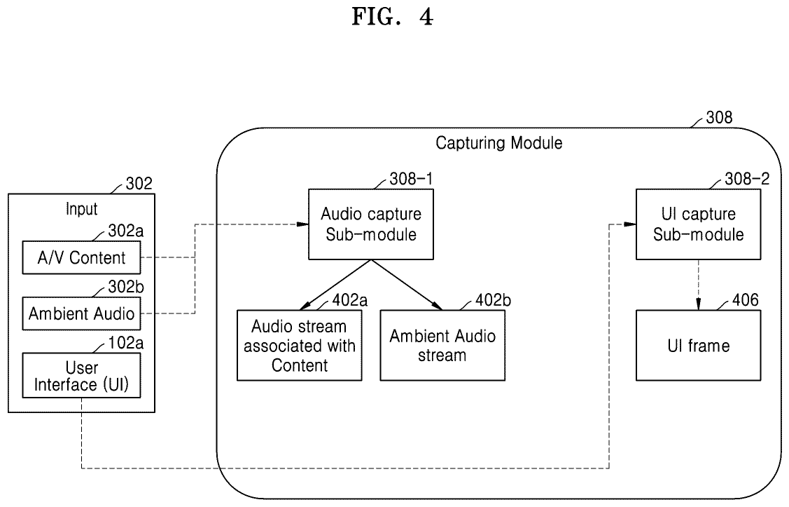

FIG. 4 illustrates a block diagram associated with the capturing module 308 of the system 200, according to an embodiment.

In an embodiment, the capturing module 308 may include the audio capture sub-module 308-1 and the UI capture sub-module 308-2. The capturing module 308 may be configured to capture an audio stream 402a, an ambient audio stream 402b, and at least one UI frame 406, associated with the content being played while the user 104 performs the traversal event. In an example, the audio capture sub-module 308-1 may be configured to capture the audio stream associated with audiovisual (AV) being played and perform Pulse Coded Modulation (PCM) to digitally represent the audio stream 402a. For example, if a movie is currently being played, the audio stream 402a may correspond to the audio of the movie. In an example, where there is no AV content being played back, the audio capture sub-module 308-1 may still generate the audio stream 402a in PCM format as output. This ensures that there is always some audio stream data available, even if actual AV content is not being played. Further, the audio capture sub-module 308-1 may be configured with a software infrastructure such as a system audio framework that facilitates audio processing and management within the system 200. The system audio framework may provide interfaces to allow the recording and provision of PCM buffers, which may contain the audio stream 402a. For instance, an Advanced Linux Sound Architecture (ALSA) may be used to capture and store the audio streams 402a.

In an example, the audio capture sub-module 308-1 may be configured to capture the ambient audio stream 402b. In an example, microphone sensors may be configured to detect and capture the ambient audio stream 402b from the environment. The microphone sensors may be configured to detect different types of sounds present in the environment, such as noise, voices, claps, verbal instructions, etc. In an example, the microphone sensors may include a microphone configured to serve as the input sensor, receiving sound signals from the environment and converting them into electrical signals. Further, the microphone sensors may include a power amplifier configured to amplify electrical signal to enhance its strength or amplitude. In an example, the microphone sensors may include a peak detector configured to detect the amplitude of the amplified signal, which identifies the highest point or peak of the signal. In an example, the microphone sensors may include an output actuator for instance a loudspeaker, configured to transform the amplified electrical signal back into a sound signal that can be listened to. In an example, the microphone sensors may be capable of detecting sound signals or the ambient audio stream 402b within a specific frequency range, for instance between 3 kHz to 6 kHz. In an example, the microphone sensors may operate within a direct current (DC) voltage range of 3.3V to 6V. Consequently, the ambient audio stream 402b is captured using the microphone sensors that may detect various environmental sounds. The captured ambient audio stream 402b is then converted into PCM data for further processing or usage.

In an embodiment, the UI capture sub-module 308-2 may be configured to capture the UI frame 406 from the UI 102a. The UI frame 406 may represent the graphical representation of the UI 102a. In an example, the UI capture sub-module 308-2 may be configured to capture or extract graphical buffers. These captured graphical buffers may be accessed using GPU 304. The graphical buffer may refer to the captured or extracted temporary storage areas that hold graphical data representing the UI 102a. The graphical buffers may contain visual elements that have been rendered and be accessed and analyzed to understand the UI 102a's graphical representation, structure, and hierarchy. Thus, the UI capture sub-module 308-2 may be configured to provide the UI frame 406 as the output. In an example, the UI frame 406 may include:

A set of images comprising a list of graphical buffers that have been rendered, encompassing both the current and next rendered buffers. The set of images may be ordered based on the depth of graphical buffers, which signifies relative position in the UI layering.

UI Level information represents the current level of the UI 102a, referring to the current node in a UI object hierarchy. The UI object hierarchy follows a parent-child relationship, and utilizing this relationship, a hierarchical tree of various UI elements may be constructed. For each UI window, this hierarchy is maintained within the application, facilitating easy retrieval of UI-level information. In an example, a graphical buffer may correspond to one or more icons that have been rendered, but are not currently displayed. For example, a user may place a cursor on a current icon that is centered in the user's field of view. If the user operates a remote to move the cursor left, right, up, or down, another icon that was not previously displayed may now become visible.

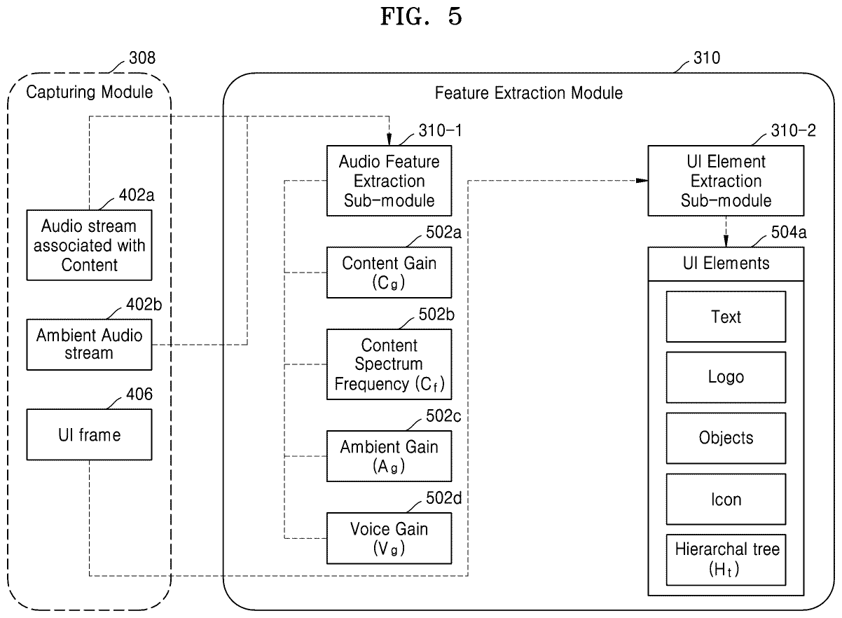

FIG. 5 illustrates a block diagram associated with the feature extraction module 310 of the system 200, according to an embodiment.

In an embodiment, the feature extraction module 310 may include the audio feature extraction sub-module 310-1 and the UI element extraction sub-module 310-2. The feature extraction module 310 may be configured to obtain (e.g., extract) a set of audio features based on the audio stream 402a, the ambient audio 402b, and the UI elements from the set of images generated based on the UI frame 406. In an example, the audio feature extraction sub-module 310-1 may be configured to receive the audio stream 402a and the ambient audio stream 402b and generate the set of audio features such as a content gain 502a (C_{g}), a content spectrum frequency (C_{f}) 502b, an ambient gain (A_{g}) 502c and a voice gain (V_{g}) 502d. In an embodiment, the input may be the PCM samples.

In one or more examples, the audio stream 402a and the ambient audio stream 402b may be a three-dimensional audio signal in which three axes may represent time, amplitude, and frequency. The audio feature extraction sub-module 310-1 may be configured to obtain (e.g., extract) the set of audio features using extraction techniques of either a time dimension or a frequency dimension. For instance, C_{g} 502a, A_{g} 502c, and V_{g} 502d are the set of audio features corresponding to the time dimension indicating the loudness of audio from the multiple audio streams (e.g., content audio and ambient audio), and C_{f} 502b corresponds to the frequency dimension.

In an embodiment, the audio feature extraction sub-module 310-1 may be configured to determine C_{g} 502a, A_{g} 502c, and V_{g} 502d based on an Amplitude Envelope (Aeₜ). The Aeₜ is calculated based on the maximum amplitude of a sample including the audio stream 402a and the ambient audio stream 402b in the UI frame 406. The Aeₜ at frame time ‘t’ may be computed by equation (1) below:

$$A {E}_{t} = {\sum }_{k = t . K}^{( t + 1 ) . ( K - 1 )} max ( s ( k ) ) , \qquad Eq . ( 1 )$$

where s(k) is the amplitude of a k^{th} sample and K is frame size (e.g., the number of samples in UI frame 406).

In an example, the audio feature extraction sub-module 310-1 may be configured to determine C_{g} 502a, A_{g} 502c, and V_{g} 502d based on Root Mean Square Energy (RMSₜ) indicating loudness and representing the measure of the average power of the audio stream 402a and the ambient audio stream 402b. The RMSₜ may be computed by equation (2) below:

$${C}_{g} , {A}_{g} , {V}_{g} = {RMS}_{t} = \sqrt{\frac{1}{K} \cdot {\sum }_{k = t . K}^{( t + 1 ) ( K - 1 )} {s ( k )}^{2}} , \qquad Eq . ( 2 )$$

where s(k) is the amplitude of the k^{th} sample and K is frame size (e.g., number of samples in UI frame 406).

In an example, the audio feature extraction sub-module 310-1 may be configured to determine C_{f} 502b indicative of a 3-D array that represents frequency, time, and input channels. The C_{f} 502b is determined by processing a Short-Time Fourier Transform (STFT) on the audio stream 402a and the ambient audio stream 402b in one or more UI frames 406 using a sliding window. In an example, the STFT corresponding to the audio stream 402a and the ambient audio stream 402b is computed by sliding an analysis window g(n) of length ‘M’ over the audio stream 402a and the ambient audio stream 402b and calculating a Discrete Fourier Transform (DFT) of each segment of the windowed data (e.g., the audio stream 402a and the ambient audio stream 402b). The window steps over the audio stream 402a and the ambient audio stream 402b received as input at intervals of R samples, equivalent to:
L=M−R samples of overlap between adjoining segments.

In an example, the audio feature extraction sub-module 310-1 may be configured to add the DFT of each windowed segment to a complex-valued matrix corresponding to an STFT matrix that contains the magnitude and phase for each point in time and frequency. Thus, the dimension of The STFT matrix may be represented by equation (3) below:

$$k = ⌊ \frac{N x - L}{M - L} ⌋ columns , \qquad Eq . ( 3 )$$

where Nₓ is the length of the signal x(n) and [·] symbols denote the floor function.

In an example, for generating the STFT Matrix X(f), the mth column of the STFT matrix may be represented by equation (4) below:

$$X ( f ) = [ \begin{matrix}{X}_{1} ( f ) & {X}_{2} ( f ) & {X}_{3} ( f ) & … & {X}_{k} ( f ) ] ,\end{matrix} \qquad Eq . ( 4 )$$

which contains the DFT of the windowed data (e.g., audio stream 402a and the ambient audio stream 402b) centered about time mR and may be represented by equation (5) below:

$${X}_{m} ( f ) = {\sum }_{n = - ∞}^{∞} x ( n ) g ( n - mR ) {e}^{- j 2 π fn} , \qquad Eq . ( 5 )$$

wherein, x(n) is the original signal, g(n) is the analysis window, m is the index representing the column of the STFT matrix, R is the hop size and ƒ is the frequency index.

Thus, the audio feature extraction sub-module 310-1 may utilize the STFT to compute the C_{f}502b using the sliding window and provide the representation of the audio stream 402a and the ambient audio stream 402b in terms of time, frequency, and input channels.

In an embodiment, the UI element extraction sub-module 310-2 may be configured to extract and categorize the UI elements 504a from the set of images, thus, facilitating further processing and analysis of the UI 102a. In an example, the UI element extraction sub-module 310-2 may be configured to identify and categorize different types of UI elements 504a within the UI 102a, such as text, logos, objects, and icons. In an example, the UI element extraction sub-module 310-2 may be configured to determine a hierarchical tree representing the relationships between the UI elements 504a. For example, based on the extracted UI elements, the UI element extraction sub-module 310-2 may determine that a first icon that a first icon (e.g., image of sports channel logo) is a parent icon of a second icon (e.g., image of football).

In an example, the UI element extraction sub-module 310-2 may use machine learning techniques such as an Efficient and Accurate Scene Text Detector (EAST) combined with Tesseract to detect and recognize text from the set of images.

In an example, the UI element extraction sub-module 310-2 may use a Multi-scale Feature Decoupling Network (MFDNet) to detect logos from the set of images by decoupling classification and regression into two branches and focusing on the classification branch.

In an example, the UI element extraction sub-module 310-2 may use machine learning techniques like YOLO (You Only Look Once) and MobileNet-SSD (Single Shot Multibox Detector) to detect objects present in the set of images and provide scores for each detection. In an example, the UI element extraction sub-module 310-2 may use classification ML techniques, such as Icon Intent, to identify icons and provide a probability score for each identified icon.

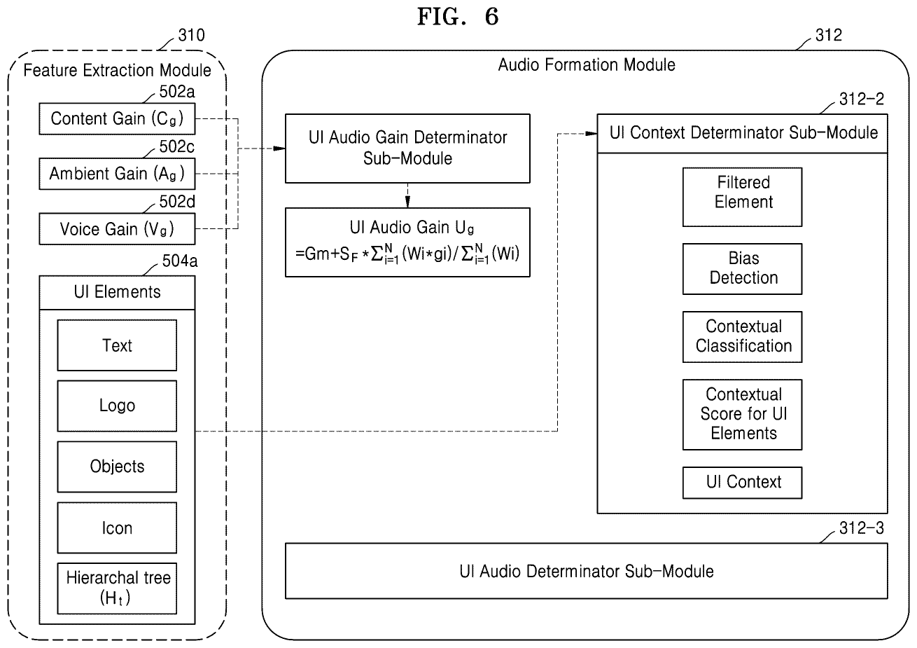

In an example, the UI element extraction sub-module 310-2 may use parent-child-sibling relationships to determine the hierarchical tree indicating relationships between the UI elements 504a. The hierarchical tree may be represented in the form of a widget with nodes with regional information corresponding to each of the UI elements 504a within the hierarchy. FIG. 6 illustrates a block diagram associated with the audio formation module 312 of the system 200, according to an embodiment.

In an embodiment, the audio formation module 312 may be configured to determine an audio gain (U_{g}) based on a prioritization and a weighted average of the extracted set of audio features. The U_{g} may indicate an intensity of the audio associated with the UI 102a. In an example, the audio formation module 312 may obtain the set of audio features C_{g} 502a, A_{g} 502c, and V_{g} 502d as input into the UI Audio Gain Determinator sub-module 312-1, configured to determine the U_{g} higher than the audio stream 402a and the ambient audio stream 402b to ensure clear differentiation to a listener. In an example, the UI Audio Gain Determinator sub-module 312-1 may be configured to determine the prioritization of the set of audio features based on a prioritized Audio list Aᵢ with higher priority denoted by A_i compared to A_(i+1).

Further, the UI Audio Gain Determinator sub-module 312-1 may be configured to determine a gain value (Gm) as the maximum of the absolute sum of audio features C_{g} 502a, A_{g} 502c, and V_{g} 502d, represented by equation (6) below:

$${G}_{m} = MAX \vert {C}_{g} + {A}_{g} + {V}_{g} \vert \qquad Eq . ( 6 )$$

In an example, the UI Audio Gain Determinator sub-module 312-1 may be configured to compute the weighted average or weighted gain (Gw) for the remaining audio sources using a weighted average approach, considering a smoothing factor (SF) in the range of 0≤SF≤1. In an example, a weight Wi associated with each of the set of audio features C_{g} 502a, A_{g} 502c, and V_{g} 502d is obtained based on pre-stored weight values from the database 207. Furthermore, the Gw may thus be computed using the equations (7) and (8) below:

$${G}_{w} = {S}_{F} * ( {W}_{1} * {g}_{1} + {W}_{2} * g 2 + … + {W}_{n} * {g}_{n} ) / ( {W}_{1} + {W}_{2} + … + {W}_{n} ) , \qquad Eq . ( 7 )$$

where S_{F} is the smoothing factor in the range of 0≤SF≤1 with default=0.2.

$${G}_{w} = {S}_{F} * {\sum }_{i = 1}^{N} ( Wi * gi ) / {\sum }_{i = 1}^{N} ( Wi ) \qquad Eq . ( 8 )$$

Consequently, the UI Audio Gain Determinator sub-module 312-1 may be configured to determine the U_{g} based on the prioritization and the weighted average such that the change in volume between the audio signal to be obtained for the UI 102a and the audio stream 402a being played in the background is gradual. For example, a change rate threshold may specify a change in decibels per second. For example, the change rate threshold may be X dB/s, where the change in volume below X dB/s is considered as a gradual change. Thus, the modified U_{g} is determined by adding the calculated Gw to the maximum gain Gm as represented by the equation (9) below:

$$Determined Audio Gain ( Ug ) = Gm + {G}_{w} \qquad Eq . ( 9 )$$

In an embodiment, the UI Context Determinator Sub-Module 312-2 may be configured to determine an UI context based on an UI contextual score of the UI elements 504a. In an example, the UI context indicates the context of activities during the traversing event corresponding to the UI 102a.

In an example, the UI Context Determinator Sub-Module 312-2 may be configured to perform an element filtering based on the UI elements 504a. In an example, the element filtering may include identifying each of the UI elements 504a separated based on respective positions within the captured UI frame 406. Further, the UI Context Determinator Sub-Module 312-2 may be configured to identify Regions of Interest (ROIs) within the UI elements 504a. The ROIs may indicate specific areas of the UI 102a where focused analysis and extraction may be required. Thus, ROIs combined with traversing the hierarchical tree provide filtering or selection of the UI elements 504a.

In an example, the UI Context Determinator Sub-Module 312-2 may be configured to determine a bias score associated with each of the UI elements 504a. In an example, the bias score may indicate a probability of each of the UI elements 504a matching with a context corresponding to the UI 102a. In an example, the bias score may be determined for logos and icons (UI elements 504a) using a trained deep neural network. In some examples, the bias score corresponding to logo Lj, may be denoted as B_{L}j and the bias score of Icon I_{I} is B_{II}.

In an example, the UI Context Determinator Sub-Module 312-2 may be configured to determine a contextual classification of the application corresponding to the UI 102 i.e., the application currently presented on the UI 102. In an example, the contextual classification may indicate a category of the application determined using a pre-trained language machine-learning model.

In an example, the contextual classification involves categorizing and generating relevant information based on the application context and genre. In an example, the ‘context’ refers to application types determined based on genre, using custom models based on pre-trained language models for instance, Bidirectional Encoder Representation from Transformers (BERT) or Generative Pre-trained Transformer (GPT-3). These models may be initially trained on extensive text data, to generate coherent and contextually relevant texts. In an example, the UI Context Determinator Sub-Module 312-2 may be configured to determine the contextual classification using (a) the app genre classification method and (b) the relevant context method. In an example, the app genre classification method may use the output layer of a custom BERT model as a classification layer, classifying input keywords into application genre classes. The resulting output is a 2D array containing application classifications along with their respective scores, enabling genre classification based on given keywords.

In an example, the relevant context method may use the output layer of custom BERT as a language generation layer, generating a sequence of words that provide context relevant to the input keywords. Thus, coherent and relevant sentences or phrases are created that explain the connection between the keywords.

Further, the UI Context Determinator Sub-Module 312-2 may be configured to obtain the UI contextual score based on the bias score and the contextual classification for each of the plurality of UI elements 504a. Consequently, the UI context indicating the context of activities during the traversing event corresponding to the UI 102a is determined based on the UI contextual score.

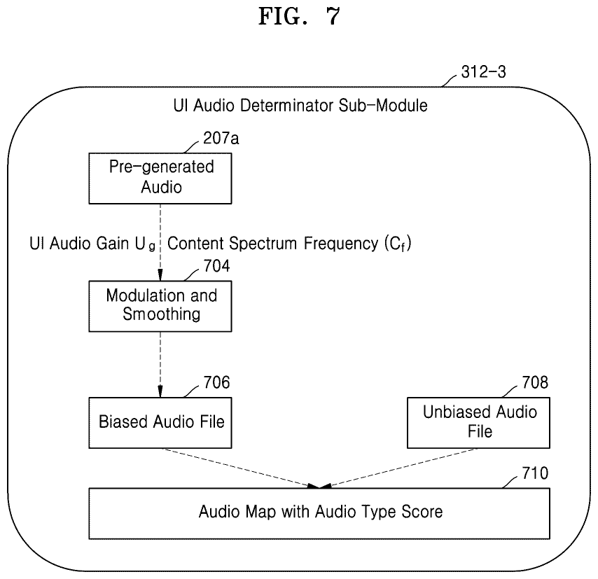

FIG. 7 illustrates a process flow of determining an audio map with the UI audio determination sub-module 312-3 associated with the audio formation module 312 of the system 200, according to an embodiment.

In an embodiment, the audio formation module 312 may be configured to obtain an audio map including one or more biased audio files and one or more unbiased audio files. In an example, the one or more biased audio files may be determined based on the set of audio features and the one or more unbiased audio files may be determined based on the determined UI context. In an example, the UI audio determination sub-module 312-3 may be configured to compare the bias score (Bs) with a predefined threshold denoted as the bias threshold (B_{Threshold}). In an example, if the Bs exceeds or equals the B_{Threshold}, the UI audio determination sub-module 312-3 may proceed to determine the audio signal using the bias method. Conversely, if the Bₛ falls below the threshold (e.g., Bₛ<B_{Threshold}), the determination of the audio signal is carried out using the unbiased audio type determination approach. Therefore, this process flow ensures accurate and effective audio type determination based on the bias scores and associated thresholds.

In an example, at FIG. 7, the UI audio determination sub-module 312-3 may be configured to receive a pre-generated audio 207a from the database 207, the U_{g}, the C_{f}, and the UI contextual score. In an example, the pre-generated audio 207a may be associated with the application.

At block 704, the UI audio determination sub-module 312-3 may be configured to scale the pre-generated audio 207a based on the U_{g} and modulate the pre-generated audio 207a based on the set of audio features (U_{g}, C_{f}) for a pre-defined time interval.

At block 706, consequently, the UI audio determination sub-module 312-3 may be configured to determine the one or more biased audio files based on modulation of the pre-generated audio 207a. Thus, the one or more biased audio files may align with the UI context. Further, the one or more biased audio files may be distinct from the audio stream 402a and the ambient audio stream 402b sounds being played in the background.

At block 708, the UI audio determination sub-module 312-3 may be configured to determine the one or more unbiased audio files. In an example, the UI audio determination sub-module 312-3 may use a custom Recurrent Neural Network (RNN) model with Long Short-Term Memory (LSTM) to determine the one or more unbiased audio files based on the UI contextual score. In an example, the RNN model may be trained using a dataset that consists of paired inputs comprising the application type and a plurality of keywords associated with the corresponding contextual audio. For instance, pairs such as {“Piano”, “Music” } and {“Guitar”, “Music” } are utilized for training. Thus, the training process helps the RNN model learn to associate the application types with the plurality of keywords and assign a weight to the plurality of keywords associated with the corresponding contextual audio based on the application. Consequently, using the RNN, the UI audio determination sub-module 312-3 may be configured to determine the one or more unbiased audio files indicating a semantic content of the audio stream 402a.

Further, at block 710, the UI audio determination sub-module 312-3 may be configured to determine the audio map (A) and associated audio type score based on the one or more biased audio files and the one or more unbiased audio files. The equation (10) below may represent output corresponding to the UI audio determination sub-module 312-3 (e.g., the audio map (A) including aggregation of the one or more biased audio files and the one or more unbiased audio files along with associated audio-type scores (As)).

$$A = M A P \{ Audio Type \{ Contexual Audio Types < > , Score {A}_{s} < > \} , Audio File \{ Biased Audio File \} \} \qquad Eq . ( 10 )$$

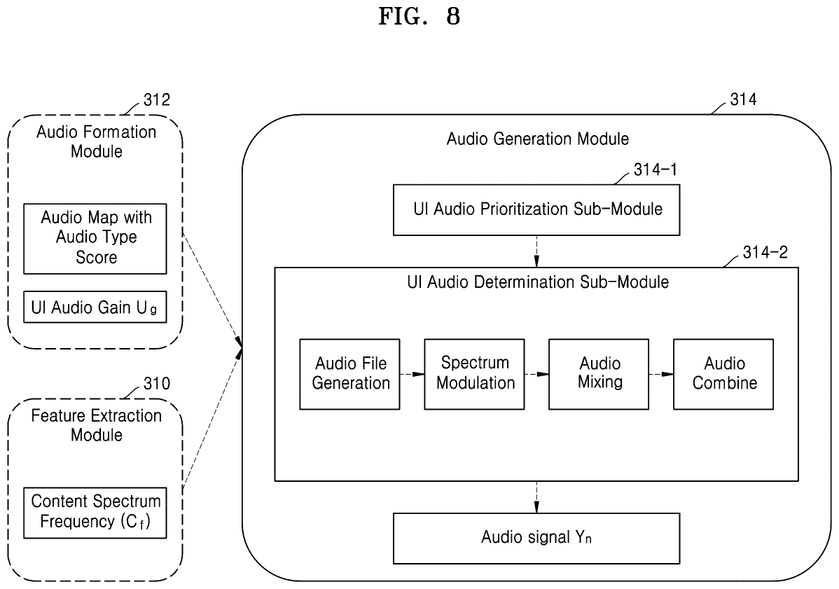

FIG. 8 illustrates a block diagram associated with the audio generation module 314 of the system 200, according to an embodiment.

In an embodiment, the audio generation module 314 may include the UI Audio Prioritization Sub-Module 314-1 and the UI Audio Determination Sub-Module 314-2.

In an example, the UI Audio Prioritization Sub-Module 314-1 may be configured to determine a priority order of the audio map (A) by arranging a sequence of the one or more biased audio files and the one or more unbiased audio files based on the audio-type scores (As) such that a set of audio types (AG) may be dynamically generated with the one or more biased audio files in a prioritized audio set (P).

In an example, the UI Audio Prioritization Sub-Module 314-1 may be configured to prioritize the one or more biased audio files by assigning higher priority (β) using a controllable weightage typically defaulting to 0.5 unless specified by the user.

In an example, the UI Audio Prioritization Sub-Module 314-1 may be configured to prioritize the one or more unbiased audio files by sorting based on the corresponding As and a threshold score. The sorting of the one or more unbiased audio files based on Aₛ may be represented using equation (11) below:

$${A}_{s} = S O R T \vert {A}_{s} , Audio type [ ] \vert \qquad Eq . ( 11 )$$

In an example, the UI Audio Prioritization Sub-Module 314-1 may be configured to prioritize a mix (M) of the one or more biased audio files and the one or more unbiased audio files based on adjusting a threshold for the one or more unbiased audio files based on the β such that higher weightage to the one or more biased audio file may be provided. In an example, audio types may be selected from the one or more biased audio files and the one or more unbiased audio files until the accumulated score reaches or exceeds the adjusted threshold. The selection may be represented using equation (12) below:

$${A}_{s 1} + {A}_{s 2} + {A}_{s 3} + {A}_{s 4} + {A}_{s 5} + … >= {Threshold}_{s} \qquad Eq . ( 12 )$$

For instance, if the first three Aₛ>=Thresholdₛ, then only the first three Audio type may be selected.

In an example, the adjusted threshold may be calculated according to equation (13) below:

$${Threshold}_{s} = 0.7 * ( 1 - β ) \qquad Eq . ( 13 )$$

Thus, dynamically generated audio types (AG) (e.g., selected one or more biased audio files and one or more unbiased audio files) based on prioritization may be represented using equation (14) below:

$$A G = \{ {A}_{s 1} , {A}_{S 2} , {A}_{S 3} \} \qquad Eq . ( 14 )$$

Consequently, the UI Audio Prioritization Sub-Module 314-1 may be configured to generate the Prioritized Audio Set (P) consisting of AG, representing dynamically generated audio types based on prioritization. The number of items in P is denoted by M, which is the total number of audio types to be included in the (P).

In an embodiment, the UI Audio Determination Sub-Module 314-2 may be configured to obtain the audio signal based on the Prioritized Audio Set (P) assigned to the one or more biased audio files and the one or more unbiased audio files associated with the audio map and the set of audio features.

In an example, the UI Audio Determination Sub-Module 314-2 may be configured to generate contextual audio files using a diffusion model such as a two-stage diffusion generator with a diffusion decoder. The generated contextual audio files based on the Prioritized Audio Set (P) may be represented using the equation (15) below:

$$A F = \{ {AF}_{1} , {AF}_{2} , … , {AF}_{M} \} ) \qquad Eq . ( 15 )$$

In an example, the UI Audio Determination Sub-Module 314-2 may be configured to perform spectrum modulation. In an example, the spectrum modulation may indicate modulating the generated audio files with C_{f} to generate a context of background audio, represented by equation (16) below:

$$A F ' n = C f * A F , \qquad Eq . ( 16 )$$

wherein AF′n may indicate a set of modulated audio files.

In an example, the UI Audio Determination Sub-Module 314-2 may be configured to generate one or more mixed audio files based on mixing the set of modulated audio files denoted as AF′={AF′1, AF′2, . . . , AF′M}, where M represents the total number of audio files to be mixed. In an example, the mixing process may be a summation operation, where each of the modulated audio files (AF′n) is added together to form a Mixed Audio File (MAF). The summation may be performed for each sample of the modulated audio files, ensuring that corresponding samples are added together to create the final mixed audio. The mathematical representation for generating the Mixed Audio File (MAF) is represented by equation (17) below:

$$M A F = {\sum }_{n = 1}^{M} A F ' n \qquad Eq . ( 17 )$$

Thus, the output MAF may be the result of summing up all the prioritized modulated audio files based on the input set of AF. Each prioritized modulated audio file contributes to the overall sound of the mixed audio, and their combined effect creates the desired auditory experience or the audio signal.

In an example, the UI Audio Determination Sub-Module 314-2 may be configured to obtain the audio signal (Yₙ) based on the Mixed Audio File MAF and U_{g}. The generation of the Yₙ may be mathematically represented using equation (18) below:

$$Yn = {\sum }_{n = - N}^{0} {Y}_{n - 1} + {\sum }_{n = 1}^{N} M A F n , \qquad Eq . ( 19 )$$

wherein Yn represents the current audio signal being generated, and MAFn represents the Mixed Audio File (MAF) at a specific time point.

In an example, after the summation, the Yₙ may be smoothed with the U_{g}. The smoothing operation may involve multiplying each audio signal by the U_{g} to adjust the audio intensity and enhance its quality. Accordingly, the Yₙ after smoothing operation may be mathematically represented using equation (19) below:

$$Yn = Ug * Yn \qquad Eq . ( 19 )$$

Accordingly, the disclosed methodology obtains the audio signal (Yₙ) during the traversal event associated with the UI 102.

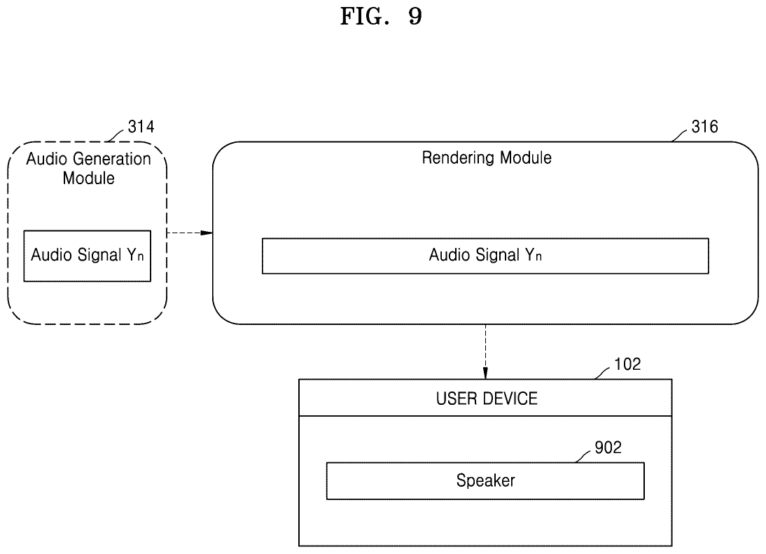

FIG. 9 illustrates a block diagram associated with the rendering module 316 of the system 200, according to an embodiment.

In an embodiment, the rendering module 316 may be configured to render or play the audio signal (Yₙ) associated with the UI 102a on the user device 102. In an example, the duration of the audio signal (Yₙ) may be estimated based on the speed at which the user 104 navigates or interacts with the UI elements 504a. This estimation of duration thus helps in synchronizing the audio signal (Yₙ) with the user's interactions, ensuring a seamless and responsive audio experience.

In an example, the user device 102 may play the audio signal (Yₙ) associated with the UI 102a. The user device 102 may include a speaker 902. The user device 102 may play the audio signal (Yₙ) through the speaker 902.

In an example, the audio signal (Yₙ) may be played with content. In an example, the audio signal (Yₙ) may be played while the UI content (e.g., buttons, menus) is being interacted with or displayed. These features can provide auditory feedback or information to the user 104 during interaction with the user device 102.

In an example, the audio signal (Yₙ) may be played without content. In an example, the audio signal (Yₙ) may be played independently, perhaps in the absence of specific UI interactions. This could be ambient sound or background audio that enhances the overall user experience.

In an example, the audio signal (Yₙ) may be rendered at a separate audio channel on the user's device 102. This separation into a distinct audio channel may ensure that the audio signal (Yₙ) is distinct from any other concurrent sounds or audio elements within the application. Further, the separate channel may allow for better control and management of the audio signal (Yₙ), enabling a more immersive and tailored auditory experience for the user 104 while navigating the UI 102a.

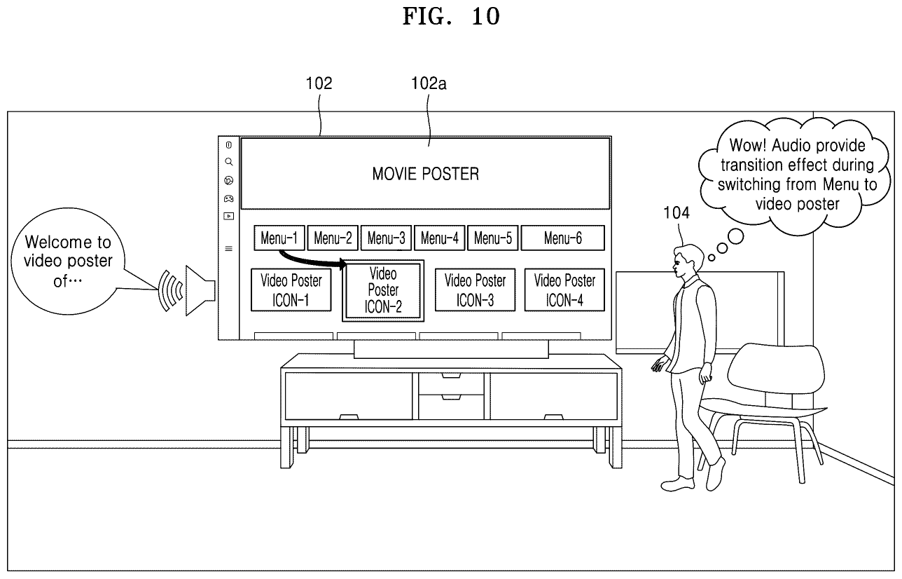

FIG. 10 illustrates a use-case of the system 200 for generating the audio signal (Yₙ) during the traversal event associated with the UI 102a corresponding to the user device 102, according to an embodiment.

In a scenario depicted as an example, the user 104 navigating through the UI 102a of a content streaming application might transition from viewing a menu to a video poster showcasing the content. In an example, the system 200 may be integrated or in communication with the user device 102. Consequently, the user device 102 may play the audio signal (Yₙ) specific to the video poster, for example, a welcoming message such as “Welcome to the video poster . . . . These features advantageously result in an enriched user experience for the user 104 while navigating within the content streaming application.

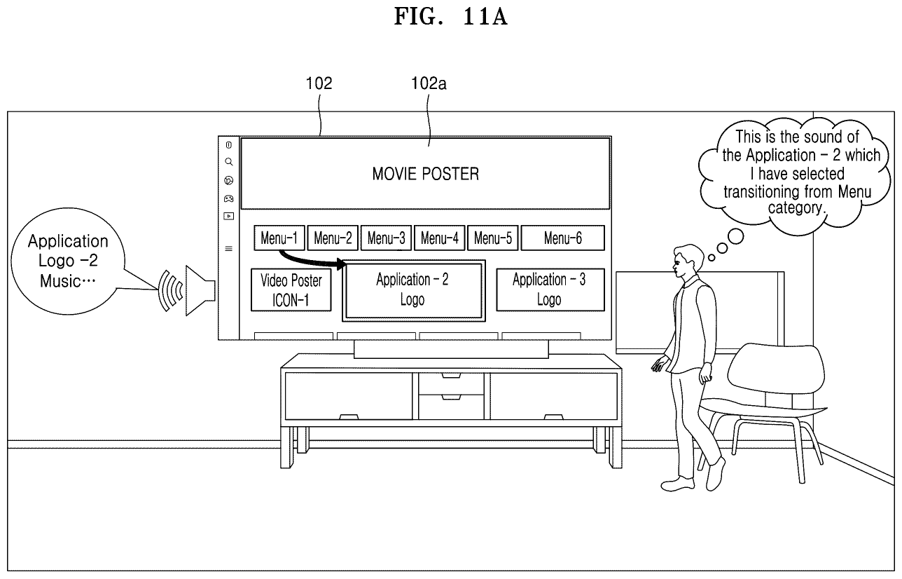

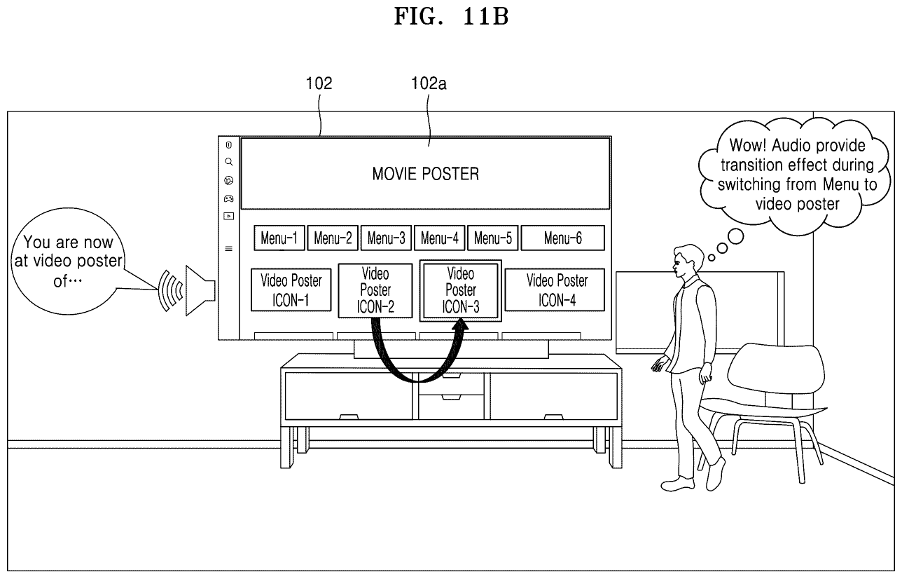

FIG. 11A illustrates another use-case of the system 200 for generating the audio signal (Yₙ) during the traversal event associated with the UI corresponding to the user device 102, according to an embodiment.

In a scenario depicted as an example, the user 104 navigating through the UI 102a of the content streaming application might transition from viewing the menu to selecting the application logo such as one of the ‘application-1 logo, application-2 logo, and application-3 logo’. In an example, the system 200 may be integrated or in communication with the user device 102. Consequently, the user device 102 may play the audio signal (Yₙ) specific to the selected application logo, for example, a theme sound specific or relevant to the selected application logo (application-2 logo). These features advantageously result in an enriched user experience for the user 104 while navigating within the UI 102a of the user device 102 such that the user 104 experience audio signal relevant to selection.

FIG. 11B illustrates another use-case of the system 200 for generating the audio signal (Yₙ) during the traversal event associated with the UI corresponding to the user device 102, according to an embodiment.

In a scenario depicted as an example, the user 104 navigating through the UI 102a of a content streaming application might transition from viewing multiple video posters showcasing the content. In an example, the system 200 may be integrated or in communication with the user device 102. As the user 104 navigates among the multiple video posters, the user device 102 may play the audio signal (Yₙ) specific to a change in the video poster, for example, “You are now at . . . ”. These features advantageously result in an enriched user experience for the user 104 while navigating within the content streaming application.

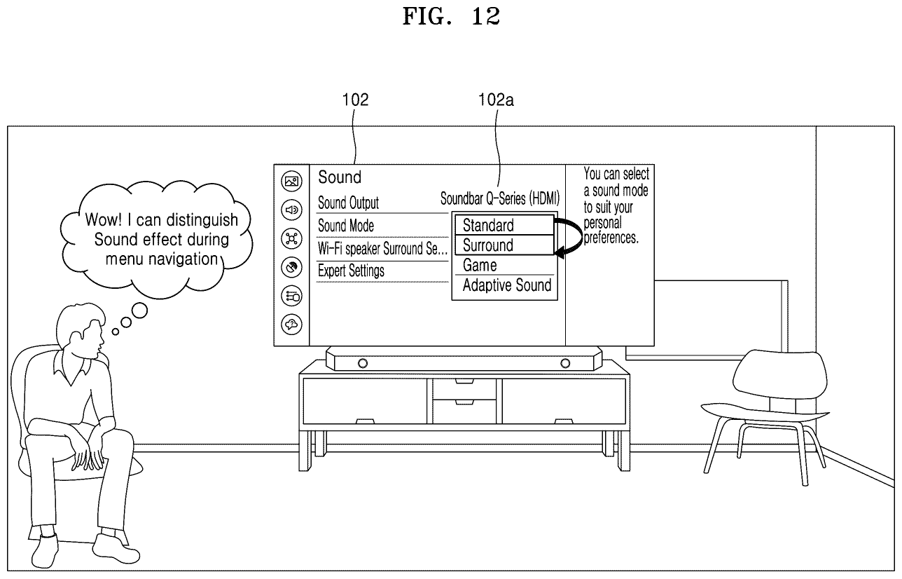

FIG. 12 illustrates another use-case of the system 200 for generating the audio signal (Yₙ) during the traversal event associated with the UI corresponding to the user device 102, according to an embodiment.

In a scenario depicted as an example, the user 104 navigating through the UI 102a corresponding to the configuration settings of the user device 102. In an example, the system 200 may be integrated or in communication with the user device 102. As the user 104 navigates in the configuration settings menu, each menu may play the audio signal (Yₙ) specific to a configuration setting or sub-menus. These features advantageously result in ease for the user 104 to relate sub-parts of the configuration settings.

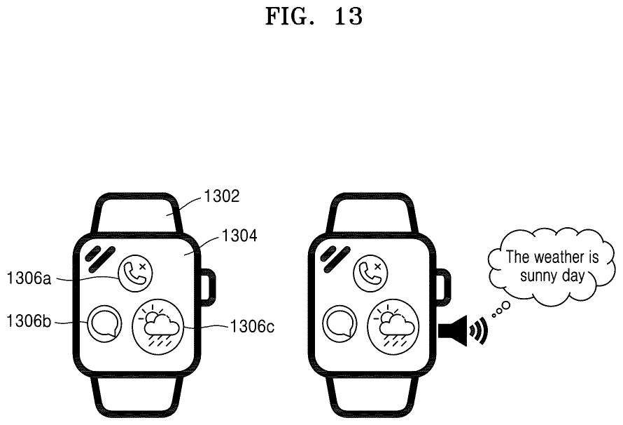

FIG. 13 illustrates another use-case of the system 200 for generating the audio signal during the traversal event associated with the UI corresponding to the user device 102, according to an embodiment.

In a scenario depicted as an example, the user 104 interacts with a smartwatch 1302 by navigating through the UI 1304. The user 104 may interact with UI elements such as multiple logos (1306a, 1306b, and 1306c) of the application. In an example, as the user 103 selects a logo (1306c) associated with the application, the smartwatch 1302 may play the audio signal (Yₙ) relevant to the context of the application and the selected logo (1306c). For instance, navigating to a weather application may play the audio signal (Yₙ) as “Weather is sunny day”. These features advantageously result in an enriched user experience for the user 104 while navigating the smartwatch 1302

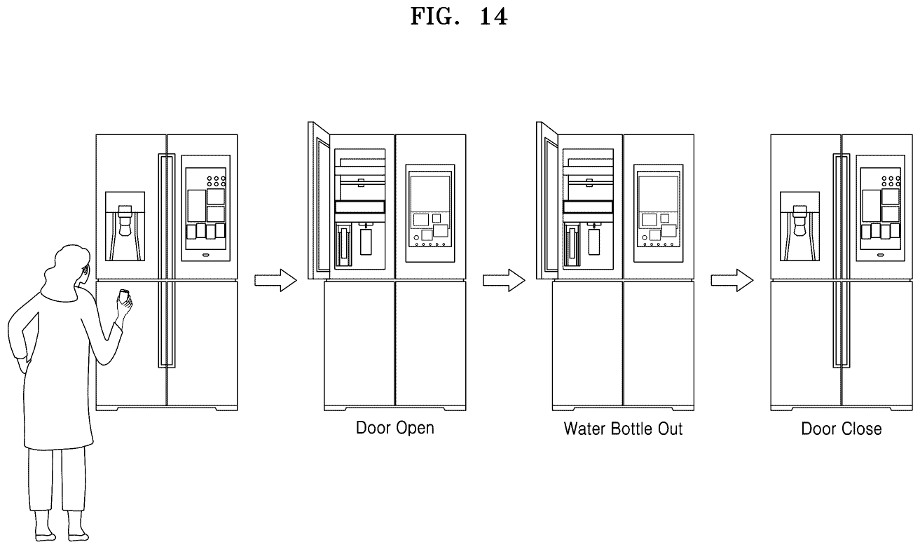

FIG. 14 illustrates another use-case of the system 200 for generating the audio signal during a physical event, while the user device 102 is operated, according to an embodiment.

In a scenario depicted as an example, the user 104 interacts with the user device 102 for instance the smart refrigerator. The user 104 may interact with the smart refrigerator by opening the door of the smart refrigerator and taking out a water bottle thus representing the physical event associated with the user device 102. As illustrated In an example, different stages of the physical event are depicted for instance, the user 104 opening the door of the smart refrigerator, followed by taking the water bottle out and finally closing the door. In an example, the system 200 may be integrated or in communication with the user device 102 (e.g., smart refrigerator). Consequently, the system 200 may capture the audio stream associated with the physical event and the ambient audio stream for the physical event. For instance, user action leading to the physical event of the door opening and taking out the water bottle may lead to generation of the audio stream. Thus, the captured audio stream may be related to such physical events while the user device 102 (smart refrigerator) is operated. The system 200 may be configured to obtain the set of audio features based on the captured audio stream and the ambient audio stream. Further, the system 200 may determine the audio gain based on the prioritization and the weighted average of the extracted set of audio feature. Furthermore, the system 200 may determine the event context based on the captured audio stream and the physical event. For instance, the sound of the door opening, and the water bottle may activate the system 200 to determine the physical event and the underlying event context. As a result, the system 200 may obtain the audio signal based on the event context and the audio gain such that the obtained audio signal corresponds to the physical event. For instance, the system 200 via the user device 102 (smart refrigerator) may play the audio signal (Yₙ) as “Door Open”, “Water bottle out” or “Door closed”. This results in an enriched user experience for the user 104 while operating the user device 102.

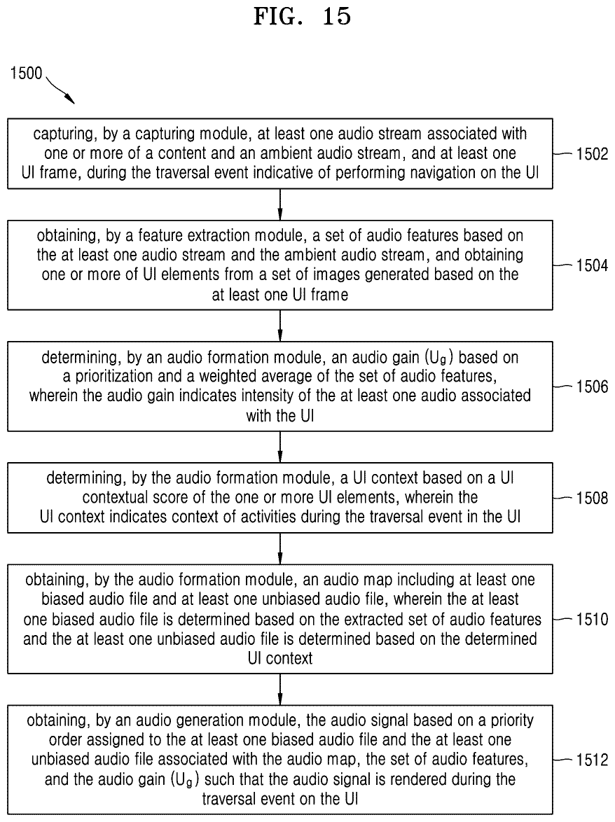

FIG. 15 illustrates an exemplary process flow comprising the method 1500 for generating the audio signal (Yₙ) during the traversal event associated with the UI 102a corresponding to the user device 102, according to an embodiment. The method 1500 may be a computer-implemented method executed, for example, by the system 200 and the modules 205. For the sake of brevity, constructional and operational features of the system 100 that are already explained in the description of FIGS. 1 through 14.

At operation 1502, the method 1500 may include capturing the at least one audio stream associated with one or more of the content and the ambient audio stream, and at least one UI frame, during the traversal event. In the method 1500, the traversal event may indicate performing navigation on the UI 102.

At operation 1504, the method 1500 may include extracting the set of audio features based on the captured at least one audio stream, the ambient audio stream, and one or more of UI elements from the set of images generated based on the captured at least one UI frame.

In the method 1500, the extracted set of audio features corresponds to the Content Gain (C_{g}), the Content Frequency (C_{f}), and the duration of the at least one audio when the captured at least one audio stream is associated with the content. Further, the extracted set of audio features corresponds to the ambience gain (A_{g}) and the vocal gain (V_{g}) of the at least one audio when the captured at least one audio is associated with the ambient audio stream.

In the method 1500, the extracted plurality of UI elements may indicate interactive components of the UI, wherein the interactive components include one or more of a text, an object, a Hierarchal tree (Hₜ), a logo, and an icon.

At operation 1506, the method 1500 may include determining the audio gain (Ug) based on the prioritization and the weighted average of the extracted set of audio features, wherein the audio gain indicates intensity of the at least one audio associated with the UI.

The method 1500 may include receiving the extracted set of audio features associated with the audio stream and the ambient audio stream respectively. Further, the method 1500 may include receiving a user voice input. Further, the method 1500 may include determining the gain value corresponding to the extracted set of audio features. Further, the method 1500 may include determining the prioritization of the extracted set of audio features based on the prioritized audio list and the determined gain value. Furthermore, the method 1500 may include obtaining the weight associated with each of the extracted set of audio features based on the pre-stored weight values. Furthermore, the method 1500 may include computing the weighted average corresponding to the extracted set of audio features based on the smoothing factor and the weight associated with each of the extracted set of audio features. Furthermore, the method 1500 may include determining the audio gain based on the prioritization and the weighted average such that the change in volume between the audio signal to be generated for the UI and the at least one audio associated with the content being played in the background, is performed at a rate below a change rate threshold.

At operation 1508, the method 1500 may include determining the UI context based on the UI contextual score of the extracted plurality of UI elements. In an example, the UI context indicates the context of activities during the traversing event in the UI.

The method 1500 may include performing the element filtering based on the extracted plurality of UI elements, wherein the element filtering comprises identifying each of the extracted plurality of UI elements separated based on respective positions within the captured at least one UI frame. Further, the method 1500 may include determining the bias score associated with each of the extracted plurality of UI elements, wherein the bias score indicates a probability of each of the extracted plurality of UI elements matching with a context corresponding to the UI. Further, the method 1500 may include determining the contextual classification of an application corresponding to the UI, wherein the contextual classification indicates a category of the application determined using a pre-trained language machine learning model. Further, the method 1500 may include generating the UI contextual score based on the bias score and the contextual classification for each of the plurality of UI elements. Furthermore, the method 1500 may include determining the UI context based on the UI contextual score.

At operation 1510, the method 1500 may include generating the audio map including the one or more biased audio files and the one or more unbiased audio files. The one or more biased audio files may be determined based on the extracted set of audio features and the one or more unbiased audio files may be determined based on the determined UI context.

The method 1500 may include obtaining the UI contextual score for each of the plurality of UI elements. Furthermore, the method 1500 may include determining the at least one unbiased audio file using a Recurring Neural Network based on the at least one audio stream associated with the content and a corresponding contextual audio indicating the semantic content of the at least one audio.

At operation 1512, the method 1500 may include generating the audio signal based on a priority order assigned to the one or more biased audio files and the one or more unbiased audio files associated with the audio map, the extracted set of audio features, and the audio gain (Ug) such that the obtained audio signal (Yₙ) is rendered during the traversal event on the UI 102.

The method 1500 may include obtaining the priority order of the audio map, the extracted set of audio features, and the determined audio gain. Further, the method 1500 may include generating one or more contextual audio files using the diffusion model based on the priority order of the audio map, wherein the one or more contextual audio files indicates the semantic content of the audio map. Furthermore, the method 1500 may include generating a context of background audio based on the modulation of the audio map with the generated contextual audio file. Furthermore, the method 1500 may include generating one or more mixed audio files based on mixing the audio map. Furthermore, the method 1500 may include generating the audio signal (Yₙ) based on the one or more mixed audio files and the determined audio gain. The method 1500 may include rendering the obtained audio signal (Yₙ) via at least one audio channel on the user device 102 corresponding to the UI 102a.

While the above discussed operations in FIGS. 4-9 are shown and described in a particular sequence, the operations may occur in variations to the sequence in accordance with various embodiments. Further, a detailed description related to the various operations of FIG. 15 is already covered in the description related to FIGS. 4-9 and is omitted herein for the sake of brevity.

The embodiments of the present disclosure provide the following advantages:

Context-aware audio refers to an audio feedback system that dynamically generates audio cues and prompts based on the context of the UI, the user's actions, and the specific elements being interacted with. By associating relevant audio cues with each UI element, users receive real-time audio feedback that corresponds directly to their interactions, creating a seamless and immersive experience.

For instance, when navigating a menu, the audio feedback could adapt based on the selected menu item, providing a distinct audio cue for each option. This not only enhances accessibility for users with visual impairments but also augments the overall user experience, making it more engaging and enjoyable.

Additionally, integrating context-aware audio into UIs enables developers to design applications and devices that are inherently more inclusive and accessible. Users with varying abilities can benefit from a tailored audio experience that caters to their specific needs and preferences, fostering a more inclusive digital environment.

In conclusion, the integration of context-aware audio into User Interfaces marks a significant leap forward in enhancing the user experience. By departing from the constraints of pre-generated audio files and embracing dynamic audio associations, we pave the way for a more personalized, intuitive, and accessible interaction with devices, ultimately revolutionizing the way users engage with technology. This innovation promises a future where user interfaces become more empathetic and attuned to individual needs, ensuring a rich and fulfilling user experience for all.

While specific language has been used to describe the disclosure, any limitations arising on account of the same are not intended. As would be apparent to a person in the art, various working modifications may be made to the method in order to implement the embodiments of the present disclosure as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

According to an embodiment of the disclosure, a method for obtaining an audio signal during a traversal event associated with a user interface (UI), the method may include rendering the audio signal via at least one audio channel on a user device corresponding to the UI.

According to an embodiment of the disclosure, the set of audio features may correspond to a content gain, a content frequency, and a duration of the at least one audio, based on the at least one audio stream being associated with the content. According to an embodiment of the disclosure, the set of audio features may correspond to an ambience gain and a vocal gain of the at least one audio, based on the at least one audio being associated with the ambient audio stream.

According to an embodiment of the disclosure, one or more UI elements may indicate interactive components of the UI. According to an embodiment of the disclosure, the interactive componenets may comprise at least one of a text, an object, a hierarchal tree, a logo, and an icon.

According to an embodiment of the disclosure, the determining the audio gain based on the prioritization and the weighted average of the set of audio features may comprise obtaining the set of audio features associated with the at least one audio stream and the ambient audio stream.

According to an embodiment of the disclosure, the determining the audio gain based on the prioritization and the weighted average of the set of audio features may comprise obtaining a user voice input. According to an embodiment of the disclosure, the determining the audio gain based on the prioritization and the weighted average of the set of audio features may comprise determining a gain value corresponding to the set of audio features. According to an embodiment of the disclosure, the determining the audio gain based on the prioritization and the weighted average of the set of audio features may comprise determining the prioritization of the set of audio features based on a prioritized audio list and the gain value. According to an embodiment of the disclosure, the determining the audio gain based on the prioritization and the weighted average of the set of audio features may comprise obtaining a weight associated with each of the set of audio features based on a pre-stored weight values. According to an embodiment of the disclosure, the determining the audio gain based on the prioritization and the weighted average of the set of audio features may comprise determining the weighted average corresponding to the set of audio features based on a smoothing factor and the weight associated with each audio feature of the set of audio features. According to an embodiment of the disclosure, the determining the audio gain based on the prioritization and the weighted average of the set of audio features may comprise determining the audio gain based on the prioritization and the weighted average such that the change in volume between the audio signal to be generated for the UI and the at least one audio associated with the content being played in the background, is performed at a rate below a change rate threshold.

According to an embodiment of the disclosure, the determining the UI context based on the UI contextual score of the one or more UI elements may comprise performing an element filtering based on the one or more UI elements, wherein the element filtering comprises identifying each of the one or more UI elements separated based on respective positions within the at least one UI frame. According to an embodiment of the disclosure, the determining the UI context based on the UI contextual score of the one or more UI elements may comprise determining a bias score associated with each of the one or more UI elements, wherein the bias score indicates a probability of each of the one or more UI elements matching with a context corresponding to the UI. According to an embodiment of the disclosure, the determining the UI context based on the UI contextual score of the one or more UI elements may comprise determining a contextual classification of an application corresponding to the UI, wherein the contextual classification indicates a category of the application determined using a pre-trained language machine learning model. According to an embodiment of the disclosure, the determining the UI context based on the UI contextual score of the one or more UI elements may comprise obtaining the UI contextual score based on the bias score and the contextual classification for each of the one or more UI elements. According to an embodiment of the disclosure, the determining the UI context based on the UI contextual score of the one or more UI elements may comprise determining the UI context based on the UI contextual score.

According to an embodiment of the disclosure, the determining the at least one biased audio file based on the set of audio features may comprise scaling a pre-generated audio based on the audio gain. According to an embodiment of the disclosure, the determining the at least one biased audio file based on the set of audio features may comprise modulating the pre-generated audio based on the set of audio features to determine the at least one biased audio file, wherein the at least one biased audio file aligns with the UI context.

According to an embodiment of the disclosure, the determining the at least one biased audio file based on the set of audio features may comprise scaling the at least one biased audio file associated with an application based on the determined audio gain (Ug). According to an embodiment of the disclosure, the determining the at least one biased audio file based on the set of audio features may comprise modulating the at least one biased audio file based on the extracted at least one audio featureset of audio features for a time-interval such that the at least one biased audio file is distinct from the at least one audio stream and the ambient audio stream being played in background.

According to an embodiment of the disclosure, determining the at least one unbiased audio file based on the UI context may comprise obtaining the UI contextual score for each of the one or more UI elements. According to an embodiment of the disclosure, determining the at least one unbiased audio file based on the UI context may comprise determining the at least one unbiased audio file using a recurring neural network based on the at least one audio stream associated with the content and a corresponding contextual audio indicating a semantic content of the at least one audio.

According to an embodiment of the disclosure, determining the corresponding contextual audio, wherein to determine the corresponding contextual audio may comprise determining a plurality of keywords associated with the corresponding contextual audio. According to an embodiment of the disclosure, determining the corresponding contextual audio, wherein to determine the corresponding contextual audio may comprise assigning a weighted score to each of the plurality of keywords associated with the corresponding contextual audio based on the application.

According to an embodiment of the disclosure, a method for obtaining an audio signal during a traversal event associated with a user interface (UI), the method may comprise aggregating the at least one biased audio file and the at least one unbiased audio file to obtain the audio map, wherein the audio map indicates a sequence of the at least one biased audio file and the at least one unbiased audio file along with associated audio-type scores.

According to an embodiment of the disclosure, a method for obtaining an audio signal during a traversal event associated with a user interface (UI), the method may comprise determining the priority order of the audio map by arranging the sequence of the at least one biased audio file and the at least one unbiased audio file based on the audio-type scores. According to an embodiment of the disclosure, the obtaining the audio signal may comprise obtaining the priority order of the audio map, the set of audio features, and the audio gain. According to an embodiment of the disclosure, the obtaining the audio signal may comprise generating one or more contextual audio files using a diffusion model based on the priority order of the audio map, wherein the one or more contextual audio files indicate semantic content of the audio map. According to an embodiment of the disclosure, the obtaining the audio signal may comprise generating a context of background audio based on a modulation of the audio map with the one or more contextual audio files. According to an embodiment of the disclosure, the obtaining the audio signal may comprise generating one or more mixed audio files based on mixing the at least one biased audio file of the audio map with the at least one unbiased audio file of the audio map. According to an embodiment of the disclosure, the obtaining the audio signal may comprise obtaining the audio signal based on the one or more mixed audio files and the audio gain.

According to an embodiment of the disclosure, the obtaining the audio signal may comprise capturing, while a user device corresponding to the UI is operated, the at least one audio stream associated with a physical event and the ambient audio stream for the physical event. According to an embodiment of the disclosure, the obtaining the audio signal may comprise extracting the set of audio features based on the at least one audio stream and the ambient audio stream.

According to an embodiment of the disclosure, the obtaining the audio signal may comprise determining the audio gain based on the prioritization and the weighted average of the set of audio features. According to an embodiment of the disclosure, the obtaining the audio signal may comprise determining an event context based on the physical event. According to an embodiment of the disclosure, the obtaining the audio signal may comprise obtaining the audio signal based on the event context and the audio gain such that the generated audio signal corresponds to the physical event.

According to an embodiment of the disclosure, the one or more instructions, when executed by the one or more processors may be configured to render the audio signal via at least one audio channel on a user device corresponding to the UI.

According to an embodiment of the disclosure, the set of audio features may correspond to a content gain, a content frequency, and a duration of the at least one audio, based on the at least one audio stream being associated with the content. According to an embodiment of the disclosure, the set of audio features may correspond to an ambience gain and a vocal gain of the at least one audio, based on the at least one audio being associated with the ambient audio stream.

According to an embodiment of the disclosure, the one or more UI elements may indicate interactive components of the UI. According to an embodiment of the disclosure, the interactive components may include at least one of a text, an object, a hierarchal tree, a logo, and an icon.

According to an embodiment of the disclosure, the one or more instructions, when executed by the one or more processors may be configured to obtain the set of audio features associated with the at least one audio stream and the ambient audio stream. According to an embodiment of the disclosure, the one or more instructions, when executed by the one or more processors may be configured to obtain a user voice input. According to an embodiment of the disclosure, the one or more instructions, when executed by the one or more processors may be configured to determine a gain value corresponding to the set of audio features. According to an embodiment of the disclosure, the one or more instructions, when executed by the one or more processors may be configured to determine the prioritization of the set of audio features based on a prioritized audio list and the gain value. According to an embodiment of the disclosure, the one or more instructions, when executed by the one or more processors may be configured to obtain a weight associated with each of the set of audio features based on a pre-stored weight values. According to an embodiment of the disclosure, the one or more instructions, when executed by the one or more processors may be configured to determine the weighted average corresponding to the set of audio features based on a smoothing factor and the weight associated with each of the set of audio features. According to an embodiment of the disclosure, the one or more instructions, when executed by the one or more processors may be configured to determine the audio gain based on the prioritization and the weighted average such that the change in volume between the audio signal to be generated for the UI and the at least one audio associated with the content being played in the background is performed at a rate below a change rate threshold.

According to an embodiment of the disclosure, the one or more instructions, when executed by the one or more processors may be configured to perform an element filtering based on the one or more UI elements, wherein the element filtering comprises identifying each of the one or more UI elements separated based on respective positions within the at least one UI frame.

According to an embodiment of the disclosure, the one or more instructions, when executed by the one or more processors may be configured to determine a bias score associated with each of the one or more UI elements, wherein the bias score indicates a probability of each of the one or more UI elements matching with a context corresponding to the UI. According to an embodiment of the disclosure, the one or more instructions, when executed by the one or more processors may be configured to determine a contextual classification of an application corresponding to the UI, wherein the contextual classification indicates a category of the application determined using a pre-trained language machine learning model. According to an embodiment of the disclosure, the one or more instructions, when executed by the one or more processors may be configured to obtain the UI contextual score based on the bias score and the contextual classification for each of the one or more UI elements. According to an embodiment of the disclosure, the one or more instructions, when executed by the one or more processors may be configured to determine the UI context based on the UI contextual score.

According to an embodiment of the disclosure, the one or more instructions, when executed by the one or more processors may be configured to scale a pre-generated audio based on the audio gain. According to an embodiment of the disclosure, the one or more instructions, when executed by the one or more processors may be configured to modulate the pre-generated audio based on the set of audio features to determine the at least one biased audio file, wherein the at least one biased audio file aligns with the UI context.

According to an embodiment of the disclosure, the one or more instructions, when executed by the one or more processors may be configured to scale the at least one biased audio file associated with an application based on the determined audio gain (Ug). According to an embodiment of the disclosure, the one or more instructions, when executed by the one or more processors may be configured to modulate the at least one biased audio file based on the set of audio features for a time-interval such that the at least one biased audio file is distinct from the at least one audio stream and the ambient audio stream being played in background.

According to an embodiment of the disclosure, the one or more instructions, when executed by the one or more processors may be configured to obtain the UI contextual score for each of the one or more UI elements. According to an embodiment of the disclosure, the one or more instructions, when executed by the one or more processors may be configured to determine the at least one unbiased audio file using a recurring neural network based on the at least one audio stream associated with the content and a corresponding contextual audio indicating a semantic content of the at least one audio.

According to an embodiment of the disclosure, the one or more instructions, when executed by the one or more processors may be configured to determine a plurality of keywords associated with the corresponding contextual audio. According to an embodiment of the disclosure, the one or more instructions, when executed by the one or more processors may be configured to assign a weighted score to each of the plurality of keywords associated with the corresponding contextual audio based on the application.

According to an embodiment of the disclosure, the one or more instructions, when executed by the one or more processors may be configured to aggregate the at least one biased audio file and the at least one unbiased audio file to generate the audio map. According to an embodiment of the disclosure, the audio map may indicate a sequence of the at least one biased audio file and the at least one unbiased audio file along with associated audio-type scores.

According to an embodiment of the disclosure, the one or more instructions, when executed by the one or more processors may be configured to determine the priority order of the audio map by arranging the sequence of the at least one biased audio file and the at least one unbiased audio file based on the audio-type scores.

According to an embodiment of the disclosure, the one or more instructions, when executed by the one or more processors may be configured to assign a first weight corresponding to the at least one biased audio file and a second weight corresponding to the at least one unbiased audio file in the priority order of the audio map. According to an embodiment of the disclosure, the first weight may be higher than the second weight.

According to an embodiment of the disclosure, the one or more instructions, when executed by the one or more processors may be configured to obtain the priority order of the audio map, the set of audio features, and the audio gain. According to an embodiment of the disclosure, the one or more instructions, when executed by the one or more processors may be configured to generate one or more contextual audio files using a diffusion model based on the priority order of the audio map, wherein the one or more contextual audio files indicate semantic content of the audio map. According to an embodiment of the disclosure, the one or more instructions, when executed by the one or more processors may be configured to generate a context of background audio based on a modulation of the audio map with the one or more contextual audio files. According to an embodiment of the disclosure, the one or more instructions, when executed by the one or more processors may be configured to generate one or more mixed audio files based on mixing the at least one biased audio file of the audio map with the at least one unbiased audio file of the audio map. According to an embodiment of the disclosure, the one or more instructions, when executed by the one or more processors may be configured to generate the audio signal based on the one or more mixed audio files and the audio gain.

According to an embodiment of the disclosure, the one or more instructions, when executed by the one or more processors may be configured to capture, while a user device corresponding to the UI is operated, the at least one audio stream associated with a physical event and the ambient audio stream for the physical event. According to an embodiment of the disclosure, the one or more instructions, when executed by the one or more processors may be configured to extract the set of audio features based on the at least one audio stream and the ambient audio stream. According to an embodiment of the disclosure, the one or more instructions, when executed by the one or more processors may be configured to determine the audio gain based on the prioritization and the weighted average of the set of audio features. According to an embodiment of the disclosure, the one or more instructions, when executed by the one or more processors may be configured to determine an event context based on the physical event.

According to an embodiment of the disclosure, the one or more instructions, when executed by the one or more processors may be configured to generate the audio signal based on the event context and the audio gain such that the generated audio signal corresponds to the physical event.

According to an embodiment of the disclosure, above devices and methods may provide a methodology to overcome the above-mentioned issues in the related techniques.

We claim:

1. A method for obtaining an audio signal during a traversal event associated with a user interface (UI), the method comprising:
capturing, during the traversal event indicative of performing navigation on the UI, at least one audio stream associated with content, an ambient audio stream, and at least one UI frame;
obtaining a set of audio features based on the at least one audio stream and the ambient audio stream, and obtaining one or more UI elements from a set of images generated based on the at least one UI frame;
determining an audio gain based on a prioritization and a weighted average of the set of audio features, wherein the audio gain indicates an intensity of the at least one audio associated with the UI;
determining a UI context based on a UI contextual score of the one or more UI elements, wherein the UI context indicates context of activities during the traversal event in the UI;
obtaining an audio map comprising at least one biased audio file and at least one unbiased audio file, wherein the at least one biased audio file is determined based on the set of audio features and the at least one unbiased audio file is determined based on the UI context; and
obtaining the audio signal based on a priority order assigned to the at least one biased audio file and the at least one unbiased audio file associated with the audio map, the set of audio features, and the audio gain, such that the audio signal is rendered during the traversal event on the UI.

2. The method according to claim 1, further comprising rendering the audio signal via at least one audio channel on a user device corresponding to the UI.

3. The method according to claim 1, wherein the set of audio features corresponds to a content gain, a content frequency, and a duration of the at least one audio, based on the at least one audio stream being associated with the content, and
wherein the set of audio features corresponds to an ambience gain and a vocal gain of the at least one audio, based on the at least one audio being associated with the ambient audio stream.

4. The method according to claim 1, wherein the one or more UI elements indicate interactive components of the UI, and
wherein the interactive components comprise at least one of a text, an object, a hierarchal tree, a logo, and an icon.

5. The method according to claim 1, wherein the determining the audio gain based on the prioritization and the weighted average of the set of audio features comprises:
obtaining the set of audio features associated with the at least one audio stream and the ambient audio stream;
obtaining a user voice input;
determining a gain value corresponding to the set of audio features;
determining the prioritization of the set of audio features based on a prioritized audio list and the gain value;
obtaining a weight associated with each of the set of audio features based on a pre-stored weight values;
determining the weighted average corresponding to the set of audio features based on a smoothing factor and the weight associated with each audio feature of the set of audio features; and
determining the audio gain based on the prioritization and the weighted average such that the change in volume between the audio signal to be generated for the UI and the at least one audio associated with the content being played in the background, is performed at a rate below a change rate threshold.

6. The method according to claim 1, wherein the determining the UI context based on the UI contextual score of the one or more UI elements comprises:
performing an element filtering based on the one or more UI elements, wherein the element filtering comprises identifying each of the one or more UI elements separated based on respective positions within the at least one UI frame;
determining a bias score associated with each of the one or more UI elements, wherein the bias score indicates a probability of each of the one or more UI elements matching with a context corresponding to the UI;
determining a contextual classification of an application corresponding to the UI, wherein the contextual classification indicates a category of the application determined using a pre-trained language machine learning model;
obtaining the UI contextual score based on the bias score and the contextual classification for each of the one or more UI elements; and
determining the UI context based on the UI contextual score.

7. The method according to claim 1, wherein the determining the at least one biased audio file based on the set of audio features comprises:
scaling a pre-generated audio based on the audio gain; and
modulating the pre-generated audio based on the set of audio features to determine the at least one biased audio file, wherein the at least one biased audio file aligns with the UI context.

8. The method according to claim 1, wherein determining the at least one unbiased audio file based on the UI context comprises:
obtaining the UI contextual score for each of the one or more UI elements; and
determining the at least one unbiased audio file using a recurring neural network based on the at least one audio stream associated with the content and a corresponding contextual audio indicating a semantic content of the at least one audio.

9. The method according to claim 1, further comprising:
aggregating the at least one biased audio file and the at least one unbiased audio file to obtain the audio map, wherein the audio map indicates a sequence of the at least one biased audio file and the at least one unbiased audio file along with associated audio-type scores.

10. The method according to claim 1, wherein the obtaining the audio signal comprises:
obtaining the priority order of the audio map, the set of audio features, and the audio gain;
generating one or more contextual audio files using a diffusion model based on the priority order of the audio map, wherein the one or more contextual audio files indicate semantic content of the audio map;
generating a context of background audio based on a modulation of the audio map with the one or more contextual audio files;
generating one or more mixed audio files based on mixing the at least one biased audio file of the audio map with the at least one unbiased audio file of the audio map; and
obtaining the audio signal based on the one or more mixed audio files and the audio gain.

11. The method according to claim 1, further comprising:
capturing, while a user device corresponding to the UI is operated, the at least one audio stream associated with a physical event and the ambient audio stream for the physical event;
extracting the set of audio features based on the at least one audio stream and the ambient audio stream;
determining the audio gain based on the prioritization and the weighted average of the set of audio features;
determining an event context based on the physical event; and
obtaining the audio signal based on the event context and the audio gain such that the generated audio signal corresponds to the physical event.

12. An electronic device for obtaining an audio signal during a traversal event associated with a user interface (UI), the electronic device comprising:
a memory storing one or more instructions; and
one or more processors operatively coupled to the memory and configured to execute the one or more instructions,
wherein of the one or more instructions, when executed by the one or more processors, cause the electronic device to:
capture, during the traversal event, at least one audio stream associated with content, an ambient audio stream, and at least one UI frame, wherein the traversal event is indicative of performing navigation on the UI;
obtain a set of audio features based on the at least one audio stream and the ambient audio stream, and extract one or more UI elements from a set of images generated based on the at least one UI frame;
determine an audio gain based on a prioritization and a weighted average of the set of audio features, wherein the audio gain indicates an intensity of the at least one audio associated with the UI;
determine a UI context based on a UI contextual score of the one or more UI elements, wherein the UI context indicates context of activities during the traversal event in the UI;
obtain an audio map comprising at least one biased audio file and at least one unbiased audio file, wherein the at least one biased audio file is determined based on the set of audio features and the at least one unbiased audio file is determined based on the UI context; and
obtain the audio signal based on a priority order assigned to the at least one biased audio file and the at least one unbiased audio file associated with the audio map, the set of audio features, and the audio gain such that the audio signal is rendered during the traversal event on the UI.

13. The electronic device according to claim 12, wherein the one or more instructions, when executed by the one or more processors, further cause the electronic device to:
render the audio signal via at least one audio channel on a user device corresponding to the UI.

14. The electronic device according to claim 12, wherein the set of audio features corresponds to a content gain, a content frequency, and a duration of the at least one audio, based on the at least one audio stream being associated with the content; and
wherein the set of audio features corresponds to an ambience gain and a vocal gain of the at least one audio, based on the at least one audio being associated with the ambient audio stream.

15. The electronic device according to claim 12, wherein the one or more UI elements indicate interactive components of the UI, and
wherein the interactive components include at least one of a text, an object, a hierarchal tree, a logo, and an icon.

16. The electronic device according to claim 12, wherein the one or more instructions, when executed by the one or more processors, further cause the electronic device to:
obtain the set of audio features associated with the at least one audio stream and the ambient audio stream;
obtain a user voice input;
determine a gain value corresponding to the set of audio features;
determine the prioritization of the set of audio features based on a prioritized audio list and the gain value;
obtain a weight associated with each of the set of audio features based on a pre-stored weight values;
determine the weighted average corresponding to the set of audio features based on a smoothing factor and the weight associated with each of the set of audio features; and
determine the audio gain based on the prioritization and the weighted average such that the change in volume between the audio signal to be generated for the UI and the at least one audio associated with the content being played in the background is performed at a rate below a change rate threshold.

17. The electronic device according to claim 12, wherein the one or more instructions, when executed by the one or more processors, further cause the electronic device to:
perform an element filtering based on the one or more UI elements, wherein the element filtering comprises identifying each of the one or more UI elements separated based on respective positions within the at least one UI frame;
determine a bias score associated with each of the one or more UI elements, wherein the bias score indicates a probability of each of the one or more UI elements matching with a context corresponding to the UI;
determine a contextual classification of an application corresponding to the UI, wherein the contextual classification indicates a category of the application determined using a pre-trained language machine learning model;
obtain the UI contextual score based on the bias score and the contextual classification for each of the one or more UI elements; and
determine the UI context based on the UI contextual score.

18. The electronic device according to claim 12, wherein the one or more instructions, when executed by the one or more processors, further cause the electronic device to:
scale a pre-generated audio based on the audio gain; and
modulate the pre-generated audio based on the set of audio features to determine the at least one biased audio file, wherein the at least one biased audio file aligns with the UI context.

19. The electronic device according to claim 12, wherein the one or more instructions, when executed by the one or more processors, further cause the electronic device to:
obtain the UI contextual score for each of the one or more UI elements; and
determine the at least one unbiased audio file using a recurring neural network based on the at least one audio stream associated with the content and a corresponding contextual audio indicating a semantic content of the at least one audio.

20. A non-transitory computer-readable storage medium storing instructions that, when executed by at least one processor, cause the at least one processor to:
capture, during the traversal event indicative of performing navigation on the UI, at least one audio stream associated with content, an ambient audio stream, and at least one UI frame;
obtain a set of audio features based on the at least one audio stream and the ambient audio stream, and obtaining one or more UI elements from a set of images generated based on the at least one UI frame;
determine an audio gain based on a prioritization and a weighted average of the set of audio features, wherein the audio gain indicates an intensity of the at least one audio associated with the UI;
determine a UI context based on a UI contextual score of the one or more UI elements, wherein the UI context indicates context of activities during the traversal event in the UI;
obtain an audio map comprising at least one biased audio file and at least one unbiased audio file, wherein the at least one biased audio file is determined based on the set of audio features and the at least one unbiased audio file is determined based on the UI context; and
obtain the audio signal based on a priority order assigned to the at least one biased audio file and the at least one unbiased audio file associated with the audio map, the set of audio features, and the audio gain, such that the generated audio signal is rendered during the traversal event on the UI.
